(19) United States
(12) Patent Application Publication
(10) Pub. No.: US 2004/0059946 A1
(43) Pub. Date: Mar. 25, 2004

(54) Network server system and method for securely publishing applications and services

(76) Inventor: Burk Pieper Price, Phoenix, AZ (US)

Correspondence Address: WEISS & MOY PC, 4204 NORTH BROWN AVENUE, SCOTTSDALE, AZ, 85251, US

(21) Appl. No.: 10/254,696

(22) Filed: Sep. 25, 2002

(51) Int. Cl. H04L 9/00

(52) U.S. Cl. 713/201; 713/182

(57) ABSTRACT

A network server system and method for securely publishing applications and services provides a flexible platform for secure, unified and balanced access to multiple data sources by client applications and users. Access to multiple data sources and granular control of security is provided in a unified request format. Security is implemented by establishing a user object within the server for each session, verifying user information for a valid session and retrieving user group membership information and storing it within the user object.

Security decisions are made in conformity with information within a request that correspond to a particular application, service and business rule. A security mask derived from the user group membership information is compared with the required security permissions at each level and/or embedded within the response data to determine what information is permitted to the user. A result is then returned in conformity with the comparison.

### BACKGROUND OF THE INVENTION

1. Field of the Invention

The present invention relates generally to server systems and more specifically, to a system for securely publishing applications and services to authenticated requesters and/or software agents.

2. Background of the Invention

The Internet, intra-nets and other network infrastructures, including dedicated wireless systems, have proliferated as networking technologies have yielded e-commerce, e-mail and new web technologies including electronic business transaction technologies.

Hosted applications and services provide data exchange and computation with client-side applications (including web browsers and e-mail programs) within the above-mentioned networks. In particular, the growth of e-business and Internet-based records management has created a huge demand for applications that can retrieve and present data extracted from varied data sources and supply them to employees, business clients and/or partners. Hosted applications typically manage data source access, and most often are hard-coded to provide interpretation of information storage formats involved in a typical records management or e-business application.

Access to hosted services, applications and data is typically managed on a per-view basis, with a view-based group memberships used to qualify users. Once access to a particular file, group of files, application or service is established, the authenticated user typically has fixed and specific access to the service, application, or files specified by the security model. Applications typically download all of the data associated with a particular request and then display all or portions of the data based upon the desired view and exclusionary rules established in the view itself. In alternative to the data filtering described above, a large number of data interfaces may be implemented, at least one for each view, providing an inflexible set of prospective requests that will each satisfy the view requirements for a particular requester. In addition, applications and services typically provide views of requested data that are fixed on a per-view or per-application basis, and generally all users have the same permissions once they are authenticated for access to a particular application or service.

The above-described architecture severely limits the flexibility of Internet server applications, provides security “holes” in which unauthorized access to data may occur, and increases database application development time and complexity. Development time is impacted due to the typical hard coding of views for particular user types and devices, while security is compromised by a single authentication and at only at the point of receiving the request for initial authentication processing. Further “authentication” might or might not occur through other static methods that are subject to compromise and duplication from unauthorized users, typically via an application login process.

Finally, accesses to information generated from Internet transactions is typically loosely managed in that requests are queued on the server in a single queue or set of queues with server load and memory requirements determined by the instantaneous volume of traffic. If the server runs out of resources, requests may be rejected or even discarded.

Therefore, it would be desirable to provide a method and system for publishing applications and services that more effectively control resource allocation and security. It would further be desirable to provide unified and flexible data access within a server system.

### SUMMARY OF THE INVENTION

The above objective of providing unified flexible data access, enhanced security and resource allocation control is provided by a method and server system that may be embodied in a computer program product including program instructions for execution within one or more network servers. The network servers may either operate independently, operate cooperatively in load balancing configurations or are coupled through standard clustering technologies, methods, and techniques.

The method and system comprise an environment that provides a uniform interface to applications executing within a server. A session is initiated by a request to the server by a network capable device and/or user or user-agent and a specialized user object is instantiated for the session. User/agent information is used to populate the user object with group membership information retrieved from a specific security schema and data source.

A request within the session is coded as a descriptor, which may be a uniform resource identifier (URI), and is passed from the user or other requesting agent to the server. Parsing the descriptor identifies a particular service, application, and business rule in specific order. A set of security flags is computed depending on the public or private nature of the service, application and business rule at each level and membership privileges of the user, as stored in the user object, in private groups of the service, application and business rule. If the user object permissions are is sufficient to support the request, the business rule, the representation of which is encapsulated in the descriptor, is executed. Otherwise, the request is rejected.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a networked computer system in which the present invention is practiced.

FIG. 2 is a block diagram depicting software modules in accordance with an embodiment of the present invention.

FIG. 3 is a flowchart depicting a security model in accordance with an embodiment of the present invention.

FIG. 4 is a flowchart depicting an access model in accordance with an embodiment of the present invention.

### DETAILED DESCRIPTION OF THE PREFERRED EMBODIMENTS

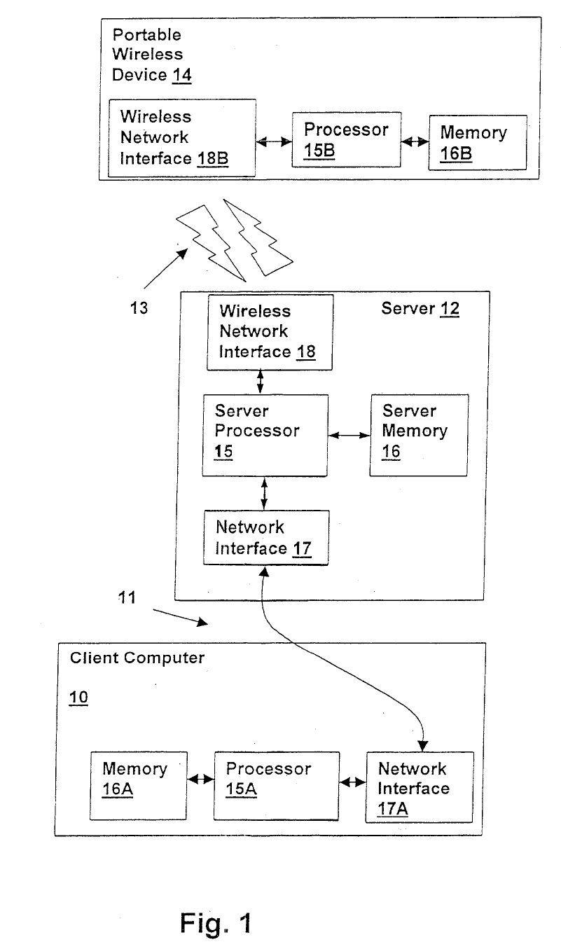

Referring now to the Figures, and with particular reference to FIG. 1, a networked computer system within which an embodiment of the present invention is practiced is depicted in a block diagram. A server system 12 includes a server processor 15 for executing program instructions is coupled to a server memory 16 containing program instructions embodying methods of the present invention. Server processor 15 is also coupled to a network interface 17 for connection to a client computer 10 and a wireless network interface 18 for connection to portable wireless device 14.

Portable wireless device 14 includes a processor 15B coupled to a memory 16B and a wireless network interface 18B for connection to a wireless local-area network (WLAN) such as an 802.11 (or other 802.xx subset) network, cellular networks, or other network. Client computer 10 also includes a processor 15A coupled to a memory 16A for executing and storing program instructions including client-side applications for connection to hosted applications within server via a wired LAN connection 11 provided through a network interface 17A coupled to processor 15A. The above-described networked computer system is exemplary only and should not be construed as limiting the scope of the present invention. The present invention concerns a hosted architecture for providing data access, security and resource management for business applications executed from server memory 12 which will generally interface with client-side programs executing within one or more devices such as client computer 10 and portable wireless device 14.

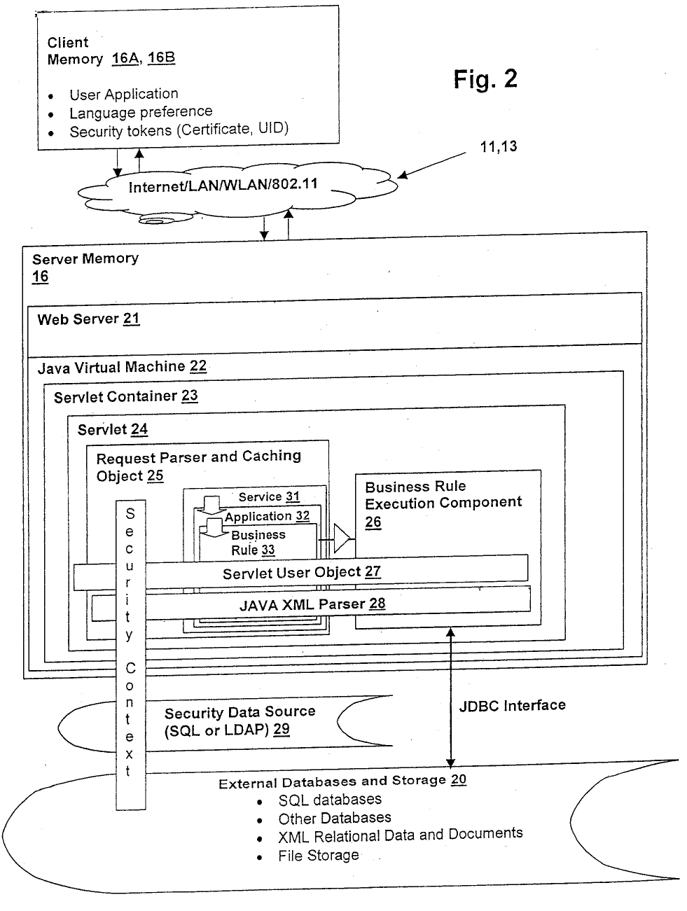

Referring now to FIG. 2, an arrangement of software modules in accordance with an embodiment of the present invention is depicted. Client memory 16A, 16B includes the above-mentioned user application and data providing a language preference, as well as security token information. A suitable token may be a user id, certificate or other token depending on security needs. The client application program connects to a servlet 24 that implements methods in accordance with embodiments of the present invention. The connection from client applications to servlet 24 is made through a web server 21 (which may be an included component of a JAVA virtual machine 22 executing from server memory 16). Examples of suitable web servers 21 are: APACHE, RESIN HTTP SERVER from Caucho Technologies, MSIIS (Microsoft Internet Information Server) and IBM WEBSPHERE, which includes its own Java Virtual Machine and servlet container. JAVA virtual machine 22 generates a container 23 for servlet 24 and executes the JAVA code comprising servlet 24. Servlet 24 provides instantiation (construction) and destruction of user objects 27 generated in response to session initiation requests from client-side applications.

Specialized user object 27 is populated with security information in the form of group memberships acquired from a security data schema 29 and data source 20 identified for the particular user device or agent that initiated the session. The security information within user object 27 is combined with security information associated with a particular service, application and business rule for each request within the session, providing continuous and multi-tiered security. The user object 27 may also have a limited lifetime, in that the server may destroy user object 27, removing the session from the system, even if a user has left the session open.

A request parser and caching object 25 decomposes the requests and allocates memory for servicing the request. A particular service 31, application 32 and business rule 33 associated with the request are identified by request parsing, and a business rule execution component 26 executes the actions encapsulated in business rule 33, if the security context of the request is valid (i.e., all of the permissions required are satisfied by matching a group membership privileges from user object 27 with each of the memberships required for the levels: service 31, application 32 and business rule 33). A specialized JAVA XML parser 28 provides both interpretation at all levels including service 31, application 32 and business rule 33 levels, as well as execution of the actions within the business rule 26. JAVA XML parser 28 also provides servlet user object 27 instantiation parameters as well as other functionality expressed in XML. The service 31, application 32 and business rule 33 are XML data structures and the actions are XML structures invoking specific function codes understood by the business rule component 26, which provides an extended syntax for implementing actions within an XML framework. An exemplary syntax is given in Table 1. It should be understood that Table 1 does not express the only syntax that may be implemented, nor does it express a closed syntax. The extended syntax is itself extensible and may be adapted to provide any functionality required.

TABLE 1

| Keyword | Action |
|---|---|
| SQL | data source interaction using SQL (Standard Query |
| | Language) |
| SMR | combine multiple data requests into one cohesive result |
| | set for further processing |
| CBA | custom business actions implement specialized internal |
| | business JAVA beans |
| UPL | Upload document or file |
| RDI | redirect request to non-default response handler |
| LOG | logging mechanism to track specific custom variables |
| | during development process or for specific production |
| | tracking variables in specified business rules |
| PVI | setting persistent serialized values specific to user |
| ADM | administrative functionality |
| CNT | row count functionality |

Requests are transmitted from clients to servlet 24 coded as uniform resource indicators (URIs) structured for example, as:

http://domain_and_host_name/Xponential/service_name/ application_name/business_rule_name?arg1=val1&argX=valX

The term Xponential identifies the trademark XPONENTIAL used within the URI to identify the URI as a URI to be handled by the server of the present invention, but may be any string or may be omitted for implementations where the server of the present invention handles all incoming requests. The terms service_name, application_name and business_rule_name identify a particular service 31, application 32 and business rule 33 for performing the request and the argument/value pairs may include user identification, data supplied with the request, and other information used in association with the request. As an example, a method in accordance with an embodiment of the present invention is invoked by the domain host server receiving the URI:

http://www.novahead.com/Xponential/Visitors/PersonalInfo/UpdateA ddress?userid=PER06262002.00000000001 and the result is that service “Visitors” and application “Personal Info” and business rule “Update Address” are implicated. The argument is the userid of the user and further information is passed in subsequent queries and posts, if security permits the user to update the address.

Servlet 24 is also responsible for security, multiplexing and demultiplexing data source requests that reference multiple and potentially disparate databases, manages cache allocation and interprets business rules that determine actions in response to requests from a client-side application.

A neutral security data source 29 is used by servlet 24 to determine a set of flags for security management. The flags are specific to each user object 27 instantiated in response to a client-side session request, and include read, write, delete and insert access flags for the service, application and business rule identified by parsing the resource identifier (e.g., URI). The present invention is differentiated from prior systems in that typically access is managed only at a “log-in” individual or group level, that is, once a user connection is established and membership in one or more groups is determined, access to applications, data sources and services is set for that connection. The present invention implements a set of flags for the service level, application level and for individual business rules. The flags are set in conformity with the permissions established for the user in the context of the service, application and business rule, based on information retrieved from security data source 29 for the particular user and stored as group membership information within user object 27. However, access to data is also based on information retrieved from the data sources themselves (e.g., a particular group membership or user ID may be required to receive particular data from a data source and the return of that data will be conditional on supplying the required permission privileges).

Servlet 24 manages all accesses to databases and other data sources 20, as well as access to applications and services within server system 12, so security can be made very granular, depending on the requirements of a particular application. Examples of suitable data sources that may be included in databases and other data sources 20 are MYSQL, POSTGRES SQL, ORACLE, MSSQL (Microsoft Corporation's SQL offering), DB2 databases as well as XML documents, XML relational database implementations and other files such as PDF (“Portable Document Format”—a format maintained by Adobe Systems, Inc.) files and text.

The ability to control access to individual business rules and to control the data set returned by that business rule for a particular user permits business rule developers to determine exactly what individuals or groups can perform particular actions. Security in the access model of the present invention is granular and at each level (service, application and business rule) is divided into public and private access domains. Public services, applications and business rules can be accessed by any user, including unauthenticated users (guests). Security flow proceeds to the next lower level when the next higher level is a public service or application. If the level is private (i.e., private service, application or business rule) the user is checked to determine whether or not they are a member of a group having permission to access that application, service or business rule. The above-described structure provides developers a high degree of flexibility in sharing data and controlling access to data and services.

An essentially public business rule can be published by an owner of that rule to permit public access by setting the group permissions to encompass all users. Therefore, a private business rule under a private application within a private service can still be made essentially public. On the other hand, a system administrator having access to the server and most or all of the core functionality may be prevented from accessing a particular business rule or result by the private owner, even if the rule is underneath a public service and application. The private owner controls the groups that can access a business rule (or elements of the result set from that business rule) and therefore a very private context can be established by the rule owner, even though that owner may have very limited access to the server in its entirety.

Business rules and data source accesses within server 12 are defined via extensible markup language (XML) documents. XML provides a platform-independent and easily maintainable mechanism for defining rule-based action requests and a mechanism for retrieving and storing elements from and to a variety of databases. JAVA based XML parser 28 provides servlet 24 with XML interpretation and manipulation services. As mentioned above, external data sources and storage 20 may include SQL, ORACLE, DB2, XML and other databases as well as storage of multiple electronic file types such as portable document format (PDF—a format maintained by Adobe Systems, Inc.) and text files.

Dedicated hosted services 31 and applications 32 (which are generally applications written for a specific e-business client or used to support multiple clients) act as organizational structures to provide functionality to a user via a set of business rules associated with a particular application 32 and a set of applications associated with a particular service 31. Servlet 24 provides access to these services and applications via URIs passed to servlet 24. Alternatively, it may be viewed that servlet 24 and the associated data source components provide data and business logic to client devices and agents. From either perspective, applications 32 and services 31 provide the core of the e-business functionality implemented to support client applications, and the functionality is implemented by actions encapsulated within business rules 33. The specific tasks underlying services 31 and applications 32 are implemented by XML business rules 33, which provide specific functions and view-specific parameters for future processing and security for returning data to the requesting device and/or agent.

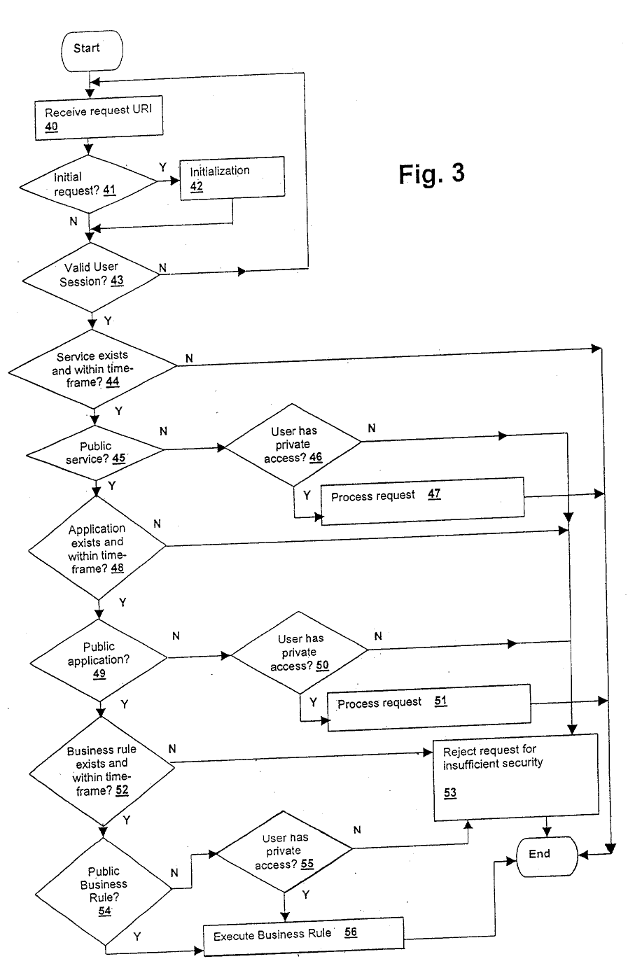

Referring now to FIG. 3, information flow within an embodiment of the present invention is depicted in a flow diagram. User object instance 32 includes functionality for maintaining a reference count, initialization, security permission flags, token verification and method interfaces for accessing applications 27, services 28 and business rules 34. Permission flags computed from user group memberships stored in user object instance 32 are used to determine whether or not a request is accepted via an interface of object instance 32 and used to access a business rule 34 or generated accesses to corresponding applications 27 or services 28. A user-side application 30 sends requests to database servlet 24. If the request is an initial request for access to a data source element, business action, etc., object instance 32 is instantiated by database servlet 24, establishing a session.

Referring now to FIG. 3, a security model in accordance with an embodiment of the invention is depicted in a flowchart. When a database request is received (step 40) by database servlet 24, if the request is an initial request (decision 41), a user object is instantiated and initialized (step 42). The user token is verified to determine whether or not the session is valid and the user is known, (step 43) and if not, the object is destroyed and the session is ended. If session is valid, but the service specified by the URI does not exist or is not within a valid publishing time framework (e.g., the session lifetime has elapsed), request processing terminates. Otherwise, if the service is private (decision 45) and if the user has private access to the service (e.g., the user is member of the service-specific group and an administrator that is a member of the administrator group or normal system user (decision 46), the request is processed 47.

If the specified service is public (decision 44) the decision tree forwards to application security checkpoints, and if the application specified by the URI does not exist or the access is not within the permitted time frame (decision 48) (e.g., a temporary application URI path has not expired), the request is rejected (step 53). Otherwise if the URI specifies a private application with a default private context (decision 49) and permission flags indicate that the object is a permitted member of an application group (decision 50), the request is processed (step 51).

If the specified service is public (decision 44) and the application is public (decision 49) the business rule name in the URI is checked to determine if it exists and also has not expired (decision 52). If the rule name has expired or does not exist (decision 52), the request is rejected (step 53). If the rule exists and has not expired (decision 52), the rule is checked to determine whether or not it is public (decision 53). If the rule is public, it is executed (step 56); if the rule is private, the rule is checked to determine whether or not the user has private access (decision 55), e.g., the user is the rule owner or a member of a permitted administrative or normal user group, then the rule is executed (step 56), otherwise the request is rejected (step 53).

Data retrieved in response to a business rule action may be restricted based on the user information and business rule and the data itself, in that servlet 24 will return only data specified by restrictions encountered (or this may be viewed as permissions/ownership information embedded in user information, the business rule and/or specified data. For example, data within a data source may specify whether the user is owner of the data or part of the data present in the data source and implicated by a request. The processing of the business rule action will result only in return of the portion of the request that is permitted to the user. In the same manner, formatting of a dynamic view returned to a user in response to a request is accomplished in that a particular user, device specification in the user info or a combination of both may determine the data returned to the client-side application, permitting adaptation of the user view to both user-specific and device-specific formatting requirements and security contexts.

The request structure also is representative of data from multiple data sources in a single request. The business rules implement access to the data sources in response to receipt of a single URI that may cause access to multiple databases, files and other data sources. The result is formatted (depending on the formatting and security permission described above) and returned to the user to provide the final user view.

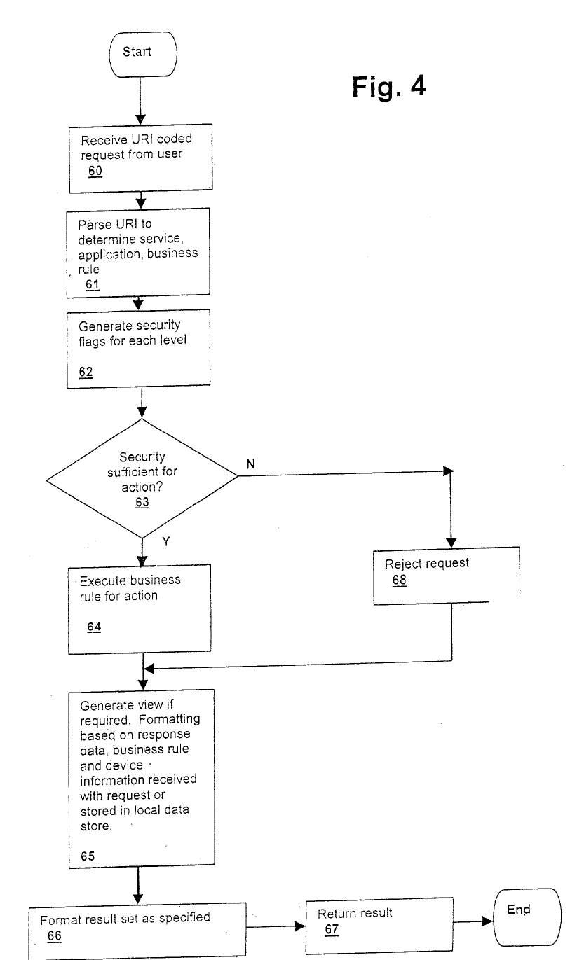

Referring now to FIG. 4, an access method in accordance with an embodiment of the present invention is depicted. A URI coded request is received from the user (step 60) and the URI is parsed to determine a particular service, application and business rule (step 61). Security flags are generated for each of the access levels: service, application and business rule (step 62). If security is sufficient for the action(s) specified by the request (decision 63 representing the flowchart of FIG. 4), the business rule for the action is executed (step 64). The result of the business rule generates a view if required (step 65), and is tailored based on the security permissions and/or device or user type as described above. The result may be formatted (step 66) according to the same XML document or a secondary document may be used (and optionally selected based on language preference, display characteristics, user type or any combination of the above). The result is then returned to the user (step 67). If the permissions were incorrect for the access, the request is rejected (step 68) and the result of the rejected request is returned by generating any necessary view (step 66), formatting the result (step 66) and returning the result (step 67) of the rejected request.

A rejected request may still result in a view or other response that represents a view of information made publicly available by the security model. For example, information on how to obtain permission for access to requested data or a display of a publicly available subset of requested data. Such data may be presented in combination or alternative to a message that the request was rejected.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for securing access to multiple functional levels within a user session on a server, comprising:
receiving user information for said user session;
determining whether or not said session is valid;
in response to determining said session is valid, instantiating a specifically defined user object within said server for managing security access to said multiple functional levels;
accessing a user schema and data source to determine group memberships for said user session;
storing said group memberships as group membership information as properties within said user object; and
subsequently accessing said multiple functional levels by providing said group membership from said user object.

2. The method of claim 1, wherein said multiple functional levels comprise service, application and business rule levels.

3. The method of claim 1, further comprising generating a view for said user session from a result of said accessing, and wherein said view is generated in conformity with view information stored within said user object.

4. The method of claim 1, wherein said accessing is performed by:
receiving a request coded as a resource identifier; and
parsing said resource identifier to extract said multiple functional levels.

5. The method of claim 4, wherein said multiple levels of access include a particular business rule, a particular application and a particular service.

6. The method of claim 4, further comprising:
calculating a set of security permissions for said user session for said multiple levels in conformity with a result of said parsing and further in conformity with said group membership privilege information stored within said user object;
evaluating whether or not said permissions are sufficient to pass on said request;
in response to determining that said permissions are not sufficient, rejecting said request; and
in response to determining that said permissions are sufficient, performing said request.

7. A server system comprising:
a processor for executing server program instructions; and
a memory coupled to said processor for storing said server program instructions, wherein said server program instructions comprise program instructions for:
receiving user information for said user session, determining whether or not said session is valid,
in response to determining said session is valid, instantiating a user object within said server for managing security access to said multiple functional levels,
accessing a user database to determine group memberships for said user session,
storing said group memberships as group membership information within said user object, and
subsequently accessing said multiple functional levels by providing said group membership from said user object.

8. The server system of claim 7, wherein said multiple functional levels comprise service, application and business rule levels.

9. The server system of claim 1, wherein said server program instructions further comprise program instructions for generating a view for said user session from a result of said accessing, and wherein said view is generated in conformity with view information stored within said user object.

10. The server system of claim 7, wherein said server program instructions for accessing comprise program instructions for:
receiving a request coded as a resource identifier; and
parsing said resource identifier to extract said multiple functional levels.

11. The server system method of claim 4, wherein said multiple levels of access include a particular business rule, a particular application and a particular service.

12. The server system of claim 4, wherein said server program instructions further comprise program instructions for:
calculating a set of security permissions for said user session for said multiple levels in conformity with a result of said parsing and further in conformity with said group membership information stored within said user object;
evaluating whether or not said permissions are sufficient to pass on said request;
in response to determining that said permissions are not sufficient, rejecting said request; and
in response to determining that said permissions are sufficient, performing said request.

13. A computer program product comprising signal-bearing media encoding server program instructions for execution within a server system, wherein said server program instructions comprise program instructions for:
receiving user information for said user session,
determining whether or not said session is valid,
in response to determining said session is valid, instantiating a specifically defined user object within said server for managing security access to said multiple functional levels,
accessing a user schema and data source to determine group memberships for said user session,
storing said group memberships as group membership information within said user object, and
subsequently accessing said multiple functional levels by providing said group membership from said user object.

14. The computer program product of claim 13, wherein said multiple functional levels comprise service, application and business rule levels.

15. The computer program product of claim 13, wherein said server program instructions further comprise program instructions for generating a view for said user session from a result of said accessing, and wherein said view is generated in conformity with view information stored within said user object.

16. The computer program product of claim 13, wherein said server program instructions for accessing comprise program instructions for:
receiving a request coded as a resource identifier; and
parsing said resource identifier to extract said multiple functional levels.

17. The computer program product of claim 16, wherein said multiple levels of access include a particular business rule, a particular application and a particular service.

18. The computer program product of claim 16, wherein said server program instructions further comprise program instructions for:
calculating a set of security permissions for said user session for said multiple levels in conformity with a result of said parsing and further in conformity with said group membership information stored within said user object;
evaluating whether or not said permissions are sufficient to pass on said request;
in response to determining that said permissions are not sufficient, rejecting said request; and
in response to determining that said permissions are sufficient, performing said request.

19. A method for handling a request coded as a resource identifier and received from a user by a server, comprising:
parsing said resource identifier to extract multiple levels of access including a particular business rule, a particular application and a particular service;
calculating a set of security permissions for said user for said multiple levels in conformity with a result of said parsing and further in conformity with user security information stored within said server;
evaluating whether or not said permissions are sufficient to pass on said request;
in response to determining that said permissions are not sufficient, rejecting said request; and
in response to determining that said permissions are sufficient, performing said request.

20. The method of claim 19, wherein said evaluating comprises:
determining whether or not said particular service is public to a group including said user; and
in response to determining that said particular service is not public to said group, determining whether or not said user has private access to said particular service, and wherein said performing said request is performed only in response to determining that said particular service is public to said group or determining that said user has private access to said particular service.

21. The method of claim 20, wherein said evaluating comprises:
in response to determining that said particular service is public to said group, determining whether or not said particular application is public to another group including said user;
in response to determining that said particular application is not public to said other group, determining whether or not said user has private access to said particular application, and wherein if said particular service is public to said other group then said performing said request is performed only in response to determining that said particular application is public to said other group or determining that said user has private access to said particular application.

22. The method of claim 21, wherein said evaluating comprises:
in response to determining that said particular service is public to said group and that said particular application is public to said other group, determining whether or not said particular business rule is public to yet another group including said user;
in response to determining that said particular business rule is not public to said yet another group, determining whether or not said user has private access to said particular business rule, and wherein if said particular service is public to said group and said particular application is public to said another group, then said performing said request is performed only in response to determining that said particular business rule is public to said yet another group or determining that said user has private access to said particular business rule.

23. The method of claim 19, wherein said evaluating comprises:
determining whether or not said particular application is public to a group including said user; and
in response to determining that said particular application is not public to said group, determining whether or not said user has private access to said particular application, and wherein said performing said request is performed only in response to determining that said particular application is public to said group or determining that said user has private access to said particular application.

24. The method of claim 19, wherein said evaluating comprises:
determining whether or not said particular business rule is public to a group including said user; and
in response to determining that said particular business rule is not public to said group, determining whether or not said user has private access to said particular business rule, and wherein said performing said request is performed only in response to determining that said particular business rule is public to said group or determining that said user has private access to said particular business rule.

25. The method of claim 19, further comprising:
receiving user information with said request;
querying a security database in response to said request to determine said user security information; and
instantiating an object containing a result of said calculating, whereby permission flags for each of said multiple levels is retained within said object for use in said evaluating.

26. The method of claim 19, further comprising generating a user view in response to a result of performing said request, wherein said view is further generated in conformity with a result of said evaluating, whereby only data for which user security permissions are appropriate is returned in response to said performing said request.

27. The method of claim 19, wherein said performing said request comprises performing data retrieval from one or more data sources by invoking said particular business rule, and wherein said particular business rule retrieves and formats a result of said data retrieval.

28. The method of claim 19, further comprising generating a user view in response to a result of performing said request, wherein said view is further generated in conformity with data returned as a result of said performing said request, whereby data is presented in a format in conformity with said business rule.

29. The method of claim 19, further comprising:
receiving formatting information from said user;
generating a user view in response to a result of performing said request, wherein said view is further generated in conformity with said formatting information.

30. A server system comprising:
a processor for executing server program instructions; and
a memory coupled to said processor for storing said server program instructions, wherein said server program instructions comprise program instructions for:
parsing a resource identifier received from a user to extract multiple levels of access including a particular business rule, a particular application and a particular service;
calculating a set of security permissions for said user for said multiple levels in conformity with a result of said parsing and further in conformity with user security information stored within said server;
evaluating whether or not said permissions are sufficient to pass on said request;
in response to determining that said permissions are not sufficient, rejecting said request; and
in response to determining that said permissions are sufficient, performing said request.

31. The server system of claim 30, wherein said program instructions for evaluating comprise program instructions for:
determining whether or not said particular service is public to a group including said user; and
in response to determining that said particular service is not public to said group, determining whether or not said user has private access to said particular service, and wherein said performing said request is performed only in response to determining that said particular service is public to said group or determining that said user has private access to said particular service.

32. The server system of claim 31, wherein said program instructions for evaluating comprise program instructions for:
in response to determining that said particular service is public to said group, determining whether or not said particular application is public to another group including said user;
in response to determining that said particular application is not public to said other group, determining whether or not said user has private access to said particular application, and wherein if said particular service is public to said other group then said performing said request is performed only in response to determining that said particular application is public to said other group or determining that said user has private access to said particular application.

33. The server system of claim 32, wherein said program instructions for evaluating comprise program instructions for:
in response to determining that said particular service is public to said group and that said particular application is public to said other group, determining whether or not said particular business rule is public to yet another group including said user;
in response to determining that said particular business rule is not public to said yet another group, determining whether or not said user has private access to said particular business rule, and wherein if said particular service is public to said group and said particular application is public to said another group, then said performing said request is performed only in response to determining that said particular business rule is public to said yet another group or determining that said user has private access to said particular business rule.

34. The server system of claim 30, wherein said program instructions for evaluating comprise program instructions for:
determining whether or not said particular application is public to a group including said user; and
in response to determining that said particular application is not public to said group, determining whether or not said user has private access to said particular application, and wherein said performing said request is performed only in response to determining that said particular application is public to said group or determining that said user has private access to said particular application.

35. The server system of claim 30, wherein said program instructions for evaluating comprise program instructions for:
determining whether or not said particular business rule is public to a group including said user; and
in response to determining that said particular business rule is not public to said group, determining whether or not said user has private access to said particular business rule, and wherein said performing said request is performed only in response to determining that said particular business rule is public to said group or determining that said user has private access to said particular business rule.

36. The server system of claim 30, wherein said server program instructions further comprise program instructions for:
receiving user information with said request;
querying a security database in response to said request to determine said user security information; and
instantiating an object containing a result of said calculating, whereby permission flags for each of said multiple levels is retained within said object for use in said evaluating.

37. The server system of claim 30, wherein said server program instructions further comprise program instructions for generating a user view in response to a result of performing said request, wherein said view is further generated in conformity with a result of said evaluating, whereby only data for which user security permissions are appropriate is returned in response to said performing said request.

38. The server system of claim 30, wherein said server program instructions for performing said request perform data retrieval from one or more data sources by invoking said particular business rule, and wherein said particular business rule retrieves and formats a result of said data retrieval.

39. The server system of claim 30, wherein said server program instructions further comprise program instructions for generating a user view in response to a result of performing said request, wherein said view is further generated in conformity with data returned as a result of said performing said request, whereby data is presented in a format in conformity with said business rule.

40. The server system of claim 30, wherein said server program instructions further comprise program instructions for:
receiving formatting information from said user;
generating a user view in response to a result of performing said request, wherein said view is further generated in conformity with said formatting information.

41. A computer program product comprising signal-bearing media encoding server program instructions for execution within a server system, wherein said server program instructions comprise program instructions for:
parsing a resource identifier received from a user to extract multiple levels of access including a particular business rule, a particular application and a particular service;
calculating a set of security permissions for said user for said multiple levels in conformity with a result of said parsing and further in conformity with user security information stored within said server;
evaluating whether or not said permissions are sufficient to pass on said request;
in response to determining that said permissions are not sufficient, rejecting said request; and
in response to determining that said permissions are sufficient, performing said request.

42. The computer program product of claim 41, wherein said program instructions for evaluating comprise program instructions for:
determining whether or not said particular service is public to a group including said user; and
in response to determining that said particular service is not public to said group, determining whether or not said user has private access to said particular service, and wherein said performing said request is performed only in response to determining that said particular service is public to said group or determining that said user has private access to said particular service.

43. The computer program product of claim 42, wherein said program instructions for evaluating comprise program instructions for:
in response to determining that said particular service is public to said group, determining whether or not said particular application is public to another group including said user;
in response to determining that said particular application is not public to said other group, determining whether or not said user has private access to said particular application, and wherein if said particular service is public to said other group then said performing said request is performed only in response to determining that said particular application is public to said other group or determining that said user has private access to said particular application.

44. The computer program product of claim 43, wherein said program instructions for evaluating comprise program instructions for:
in response to determining that said particular service is public to said group and that said particular application is public to said other group, determining whether or not said particular business rule is public to yet another group including said user;
in response to determining that said particular business rule is not public to said yet another group, determining whether or not said user has private access to said particular business rule, and wherein if said particular service is public to said group and said particular application is public to said another group, then said performing said request is performed only in response to determining that said particular business rule is public to said yet another group or determining that said user has private access to said particular business rule.

45. The computer program product of claim 41, wherein said program instructions for evaluating comprise program instructions for:
determining whether or not said particular application is public to a group including said user; and
in response to determining that said particular application is not public to said group, determining whether or not said user has private access to said particular application, and wherein said performing said request is performed only in response to determining that said particular application is public to said group or determining that said user has private access to said particular application.

46. The computer program product of claim 41, wherein said program instructions for evaluating comprise program instructions for:
determining whether or not said particular business rule is public to a group including said user; and
in response to determining that said particular business rule is not public to said group, determining whether or not said user has private access to said particular business rule, and wherein said performing said request is performed only in response to determining that said particular business rule is public to said group or determining that said user has private access to said particular business rule.

47. The computer program product of claim 41, wherein said server program instructions further comprise program instructions for:
receiving user information with said request;
querying a security database in response to said request to determine said user security information; and
instantiating an object containing a result of said calculating, whereby permission flags for each of said multiple levels is retained within said object for use in said evaluating.

48. The computer program product of claim 41, wherein said server program instructions further comprise program instructions for generating a user view in response to a result of performing said request, wherein said view is further generated in conformity with a result of said evaluating, whereby only data for which user security permissions are appropriate is returned in response to said performing said request.

49. The computer program product of claim 41, wherein said server program instructions for performing said request perform data retrieval from one or more data sources by invoking said particular business rule, and wherein said particular business rule retrieves and formats a result of said data retrieval.

50. The computer program product of claim 41, wherein said server program instructions further comprise program instructions for generating a user view in response to a result of performing said request, wherein said view is further generated in conformity with data returned as a result of said performing said request, whereby data is presented in a format in conformity with said business rule.

51. The computer program product of claim 41, wherein said server program instructions further comprise program instructions for:
receiving formatting information from said user;
generating a user view in response to a result of performing said request, wherein said view is further generated in conformity with said formatting information.
